(19) United States
(12) Patent Application Publication
(10) Pub. No.: US 2013/0281565 A1
(43) Pub. Date: Oct. 24, 2013

(54) Methods For Water-Borne Thiol-Ene Polymerization

(71) Applicants: Devon Andrew Shipp, Potsdam, NY (US); Sitaraman Krishnan, Potsdam, NY (US); Olivia Z. Durham, Sterling, NY (US)

(72) Inventors: Devon Andrew Shipp, Potsdam, NY (US); Sitaraman Krishnan, Potsdam, NY (US); Olivia Z. Durham, Sterling, NY (US)

(73) Assignee: CLARKSON UNIVERSITY, Potsdam, NY (US)

(21) Appl. No.: 13/867,702

(22) Filed: Apr. 22, 2013

Related U.S. Application Data
(60) Provisional application No. 61/636,046, filed on Apr. 20, 2012.

(51) Int. Cl. C08J 3/28

(52) U.S. Cl. CPC C08J 3/28
USPC 522/180

(57) ABSTRACT

A method for suspension polymerization of thiol-ene particles comprising combining a plurality of thiol-ene precursor monomers with or without a solvent to create a first mixture, combining an emulsifier and water to create a second mixture, adding an initiator to either the first or second mixture, adding the first mixture and the second mixture to create a third mixture, agitating the third mixture to create a heterogeneous dispersion, and initiating polymerization of thiol-ene particles from the thiol-ene precursor monomers in the third mixture which is simultaneously agitated.

### CROSS-REFERENCE TO RELATED APPLICATIONS

This application claims priority to U.S. Provisional Patent Application Ser. No. 61/636,046, filed on Apr. 20, 2012 and entitled “Water-Borne Thiol-Ene Polymerization,” the entire disclosure of which is incorporated herein by reference.

### BACKGROUND OF THE INVENTION

1. Field of the Invention

The present invention relates to thiol-ene polymerization and, more specifically, to methods for water-borne thiol-ene polymerization.

2. Description of the Related Art

Thiol-ene reactions involve the addition of an S—H bond across a double or triple bond. These reactions are highly tolerant of a wide range of functional groups, solvents, and reaction conditions, and produce high yields with little or no byproducts. Indeed, the mechanism of the thiol-ene reaction offers many practical advantages to polymer synthesis. This particular chemistry involves relatively simple reactions that can result in potentially uniform crosslinked systems. In addition, this system incorporates readily available monomers that offer a large variety of compatibility for numerous multifunctional thiol and alkene monomers. Furthermore, the utilization of this step-growth mechanism allows for high rates of conversion of monomers to polymers potentially with high molecular weight.

Interest in thiol-ene polymerizations has increased in recent years with the development of thiol-ene reactions as a method of “click” chemistry for small molecule syntheses. Consequently, the use of thiol-ene chemistry for the development of a crosslinked colloidal assembly offers promise for research into new areas of materials and applications. Water-borne thiol-ene polymerization that follows a suspension-like mechanism is one particular area that, as yet, has not been developed, in stark contrast to the widely practiced water-borne polymerizations of acrylics and styrenic monomers. Development of suspension, dispersion, and various types of emulsion polymerizations using these latter monomers has occurred over many years as a response to ever increasing requirements in manufacturing and environmental controls. Thiol-ene polymerizations have been often used in thin films and coatings, but in bulk rather than in an emulsified system.

The utilization of thiol-ene chemistry for the synthesis of water-borne polymer microspheres offers great potential toward the development of a novel material system for various applications. The step-growth mechanism of thiol-ene polymerization means that the production of such microspheres is fundamentally different to regular chain-growth polymerizations normally associated with emulsion, dispersion, and suspension polymerizations. Accordingly, there is a continued need for methods, systems, and mechanisms of water-borne thiol-ene polymerization that follow a suspension-like mechanism.

### BRIEF SUMMARY OF THE INVENTION

According to an aspect, a method for suspension polymerization of thiol-ene particles, the method comprising the steps of: (i) combining a plurality of thiol-ene precursor monomers, with or without a solvent, to create a first mixture; (ii) combining an emulsifier and water to create a second mixture; (iii) combining an initiator, with or without a solvent, to either the first or second mixture; (iv) combining the first mixture and second mixture to create a third mixture; (v) agitating the third mixture to create a heterogeneous dispersion; and (vi) initiating polymerization of thiol-ene particles from the thiol-ene precursor monomers in the third mixture, wherein the third mixture is simultaneously agitated.

According to another aspect, the first mixture, second mixture, and/or initiator comprises a solvent.

According to an aspect, the thiol-ene precursor monomers are selected from the group consisting of: a thiol compound, an alkene, an alkyne, and combinations thereof. According to one embodiment, the thiol compound comprises one or more thiol groups. According to yet another embodiment, the alkene comprises one or more alkene groups, and/or the alkyne comprises one or more alkyne groups.

According to another aspect, the second mixture further comprises a stabilizer.

According to yet another aspect, polymerization is induced through photochemical, redox, or thermal means.

According to an aspect, the third mixture further comprises a first compound, wherein the first compound affects a characteristic of the polymerized thiol-ene particles. The characteristic can be, for example, hardness, hydrophilicity, hydrophobicity, biocompatibility, particle size, stability, or a thermal property.

According to an aspect, the first compound is a diluent selected from the group consisting of: chloroform, toluene, dichloromethane, 1,4-dioxane, tetrahydrofuran, ethyl acetate, or other common diluent compounds, and combinations thereof.

According to yet another aspect, the polymerized thiol-ene particles comprise a crosslinked or linear structure.

According to an aspect, the polymerized thiol-ene particles comprise a diameter that is dependent upon the energy input of the agitation. According to an embodiment, the diameter is between approximately 100 nm and 1 mm.

According to an aspect, after the polymerization is induced the third mixture comprises a solids content ranging between approximately 1% and 30%.

According to another aspect, the emulsifiers are selected from the group consisting of common anionic, cationic or non-ionic emulsifies, such as and not limited to sodium dodecyl sulfate (SDS), dodecyltrimethyl ammonium bromide, Tween, Gum Arabic, and combinations thereof. The emulsifiers can be added, for example, at a concentration of between approximately 0.01% and 20%.

According to an aspect, the initiator is a free radical initiator. According to yet another aspect, the initiator is a photoinitiator, a thermal initiator, and/or a redox initiator. Non-limiting examples include, for example, 1-hydroxycyclohexyl phenyl ketone, 2,2′-azobisisobutyronitrile, benzoyl peroxide, and combinations thereof, among others. According to an aspect, the initiator is added at a concentration of between approximately 0.05%-5%.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is schematic representation of thio-ene polymer particle formation according to an embodiment;

FIGS. 2A and 2B are optical microscope images of photoinitiated reactions according to an embodiment with a triene, 3,5-triallyl-1,3,5-triazine-2,4,6 (1N,3H,5H)-trione (“TTT”) and a tetrathiol, (pentaerythritol tetrakis(3-mercaptopropionate) (“PETMP”) with 5 wt. % SDS in a “small scale” reaction with 10 wt. % monomers in water with a 1:1 volume ratio monomers:chloroform, at different homogenization energies (FIG. 2A is stir rate 4 and FIG. 2B is right stir rate 8) using a magnetic stir plate;

FIG. 3 is a scanning electron microscopy image of a photoinitiated overhead-stirring reaction with TTT and PETMP examining 10 wt. % SDS in a “large scale” reaction with 10 wt. % monomers and a 1:1 volume ratio of monomers:toluene, according to an embodiment;

FIGS. 4A and 4B are scanning electron microscopy images of photoinitiated sonicated reactions with TTT and PETMP examining 10 wt. % SDS in a “large scale” reaction with 10 wt. % monomers and a 1:1 volume ratio of monomers:toluene, according to an embodiment;

FIG. 5 contains a graph of differential scanning calorimetry analysis of polymer made by either suspension polymerization to yield particles, or bulk polymerization to yield monolithic samples, according to an embodiment, in which both samples have the same composition (1:1 mole ratio of ene and thiol groups from TTT and PETMP, respectively).

### DETAILED DESCRIPTION OF THE INVENTION

Described herein are methods for water-borne thiol-ene photopolymerization which, according to an embodiment, yield spherical polymer particles. The utilization of this method offers great potential as a method for the development of crosslinked polymer (sub-) micron spheres. According to embodiments, different parameters are used for the development and understanding of the mechanism of microsphere formation. It is demonstrated that higher homogenization power allows for the development of smaller particles. In addition, higher concentrations of surfactant as well as solvent allow for the development of non-aggregated polymer particles that are smaller in size. This approach is predicted to work with a variety of thiol-ene (or yne) monomers, surfactants and co-solvents.

According to one embodiment, thiol-ene polymerizations are conducted in a water-borne suspension-like polymerization. Using the method, spherical particles can be synthesized with a range of diameters, ranging from sub-microns to hundreds of microns. According to an embodiment, particle size and dispersion stability are dependent upon various experimental variables, including but not limited to stirring rate, surfactant concentration, and amount of solvent used to dissolve the viscous monomers. With initiation occurring in the organic phase along with particle size being strongly dependent upon homogenization energy and surfactant concentration, it is inferred that microsphere synthesis follows a suspension mechanism.

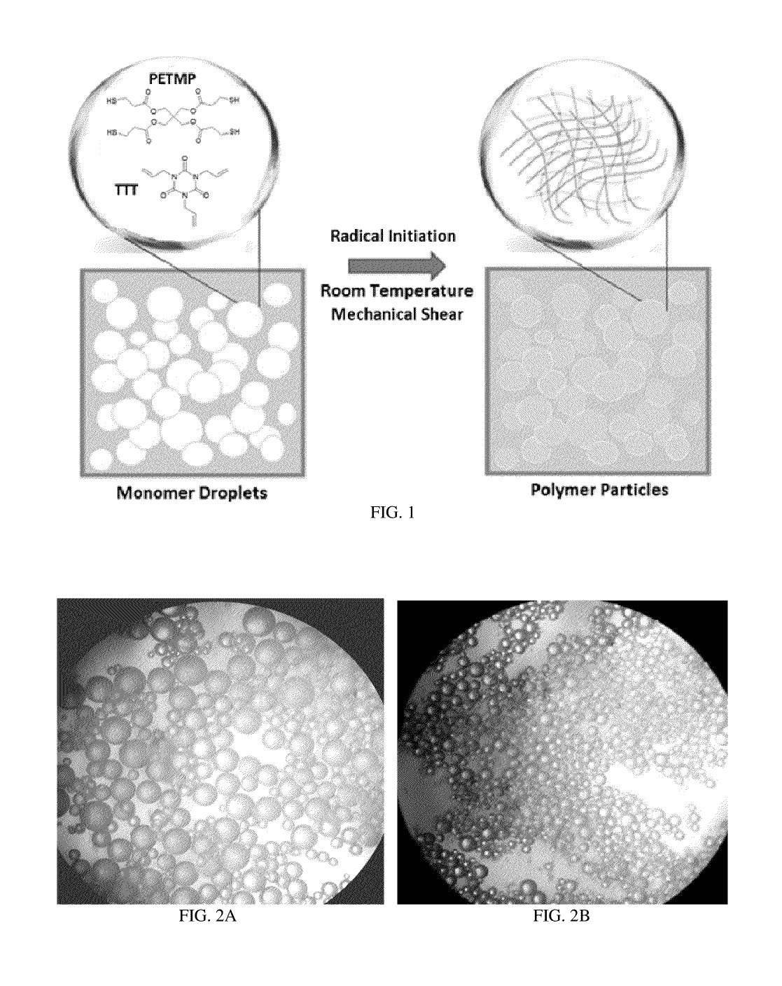

The approach used in the production of water-borne thiol-ene polymers according to one embodiment is outlined in FIG. 1, and is discussed in greater detail herein. Notably, the use of a crosslinking polymerization, i.e. using the PETMP and/or TTT, was found to be necessary for successful particle formation.

### Example 1

### Thiol-Ene Particles

According to one embodiment, thiol-ene particles are made using monomers TTT and PETMP in a ratio that provide equal number of ene and thiol functionality. Because TTT and PETMP are viscous liquids, it was necessary to add a co-solvent to the monomers before this solution was added to the water/surfactant mixture. The commonly used surfactant SDS was chosen, and used at either a 5 or 10 wt. % (SDS/water) concentration. Other surfactants, such a non-ionic (e.g. Brij98) and cationic (e.g. dodecyltrimethylammonium bromide) surfactants, can also be used, as can different amounts and concentrations of surfactants. Photoinitiation was used as the method for generating radical species, although thermal and redox decomposition of initiators can also be performed. Photoinitiation is unusual for water-borne polymerizations, but is common for thiol-ene polymerizations. Photopolymerization rates tend to be very fast, and allow spatial and temporal control. In this particular application, photopolymerization was successful because of the highly efficient thiol-ene chemistry used, and adds to the uniqueness of this approach to the synthesis of polymer particles.

According to an embodiment, a simple magnetic stirrer and a small reaction volume (˜10 ml total) in a scintillation vial and a small magnetic stir bar (˜8 mm diameter, ˜1 mm length) were utilized. The settings on the stirrer could be adjusted to provide more or less shear in the reaction mixture. The optical microscope images shown in FIG. 2 show that under these conditions spherical polymer particles were formed, with diameters ranging from tens-to-hundreds of microns. Such a diameter range, however, means the particle size distribution is relatively large. It was found that by increasing the surfactant concentration that the particle size decreased somewhat (data not shown), but not to the sub-micron range.

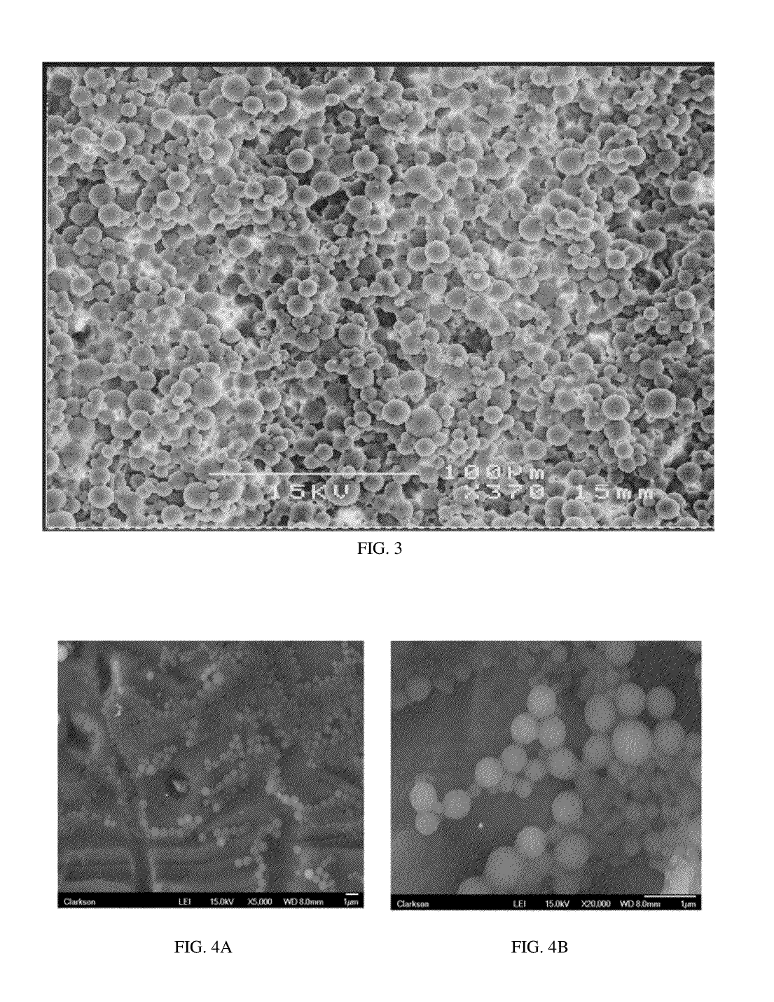

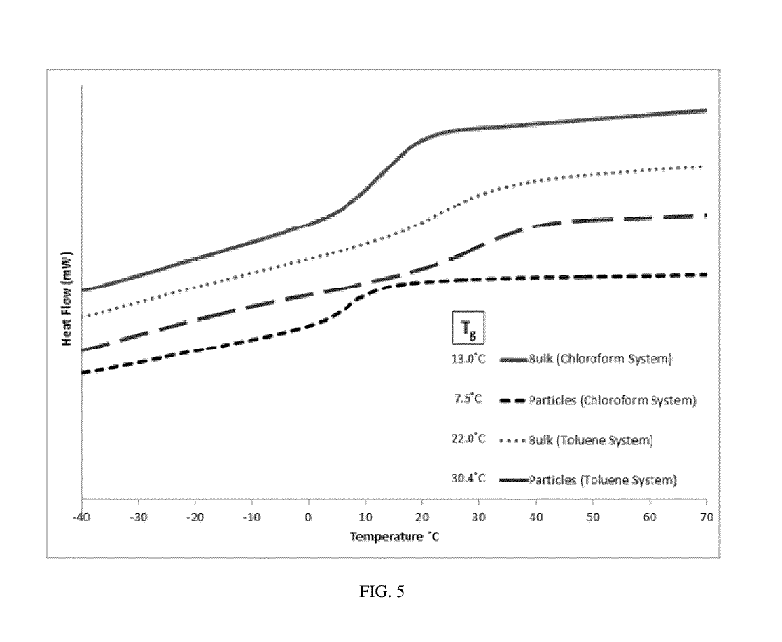

According to another embodiment, a more energetic stifling process is utilized in order to decrease particle size and reduce the particle size distribution. This agitation method consisted of an overhead stirrer and 75 ml of the reaction mixture placed in a 250 ml round-bottom flask. FIG. 3 shows particles with 5-20 μm diameters made using an embodiment of the overhead stirred “large scale” reaction, which provides an approximate 10 times decrease in particle size. However, the size distribution is still not monodisperse.

According to another embodiment, sonication was used in order to further decrease particle size and possibly narrow the particle size distribution. The reaction mixture (75 ml) in a 250 ml round-bottom flask was exposed to a sonic horn for 30 minutes, and after 20 minutes was the reaction was irradiated (with overhead stifling) for 10 minutes. FIG. 4 shows particles with ˜100-1000 nm diameters made using the sonication approach. While this is again a substantial decrease in particle size, the distribution is not monodisperse. This may be a function of monomer droplet stability, thus dependent on dispersion energy and/or surfactant type/concentration, thus efforts are underway to explore these parameters more fully with the expectation that more monodisperse particles will be produced.

The suspensions made from the three different means of mixing showed varying degrees of colloidal stability. As expected, the smaller particle sizes made with sonication showed the longest period of stability, with the solution remaining dispersed for several days after polymerization with little material settling out. In contrast, the material made with stifling from the magnetic stirrer settled out within an hour of synthesis.

In terms of the mechanism by which particle formation takes place, these reactions appear to be occurring via a suspension polymerization process. This terminology is normally associated with radical chain-growth mechanism of polymerization (where high molecular weight polymers are formed at a very early stage in the polymerization) that is initiated with an oil-soluble initiator. This is compatible with the present case where the step-growth thiol-ene mechanism can occur inside the monomer droplet when initiated by the oil-soluble initiator. Further evidence that these are suspension polymerizations comes from the fact that the size of the polymer particles decreases with increasing surfactant concentration and increasing homogenization energy. In contrast, emulsion polymerizations typically require water-soluble initiators and typically need particle nucleation to occur when the growing polymer chain in the aqueous phases reaches a critical molecular weight and phase inversion. Because thiol-ene polymerizations only achieve appreciable molecular weights at high conversions (i.e. they are step-growth polymerizations), the latter phenomenon is not likely to occur in our systems. Conventional emulsion and micro-emulsion polymerizations generally do not exhibit a dependence of particle size on homogenization energy, in contrast to what we have seen here. Additionally, the experiments shown here have a surfactant concentration above the critical micelle concentration (“CMC”) (the CMC of SDS is approximately 0.009 mole/L; 10 wt. % SDS in water is 0.35 mole/L), and if emulsion polymerizations by micellar nucleation were occurring, then the particle sizes would be significantly smaller and not dependent on the homogenization energy. The current system is also not a dispersion polymerization, as dispersion polymerizations begin with a homogeneous monomer-solvent mixture and become heterogeneous as monomer conversion increases. The descriptions of the different heterogeneous polymerization reaction mechanisms given herein are consistent with those in Lovell and El-Aasser [Emulsion Polymerization and Emulsion Polymers; Lovell, P. A.; El-Aasser, M. S. Eds.; Wiley: Chichester, Great Britain, 1997].

In order to examine any differences between the thiol-ene polymers made via the suspension polymerization and bulk polymerizations, the glass transition temperatures (T_{g}) of the two types of polymers were measured using DSC. The T_{g} values for the particles and bulk material were found to be essentially the same (−1° C. and +3° C., respectively), indicating that the polymerization process occurring during the water-borne polymerization is the same as that which occurs during the bulk polymerization. Also, the presence of surfactant in the particles does not significantly affect the thermal properties.

In comparison to other works in the field, there are no reports of thiol-ene suspension polymerizations. In one recent paper, porous thiol-ene (and thiol-yne) based polymers were made via an emulsion-templating process [Lovelady, E.; Kimmins, S. D.; Wu, J.; Cameron, N. R. “Preparation of Emulsion-Templated Porous Polymers using Thiol-Ene and Thiol-Yne Chemistry” Polym. Chem. 2011, 2, 559-562]. In these experiments a mixture of water, a polymeric surfactant, chloroform and thiol-ene (or yne) monomers were blended to make a high internal phase emulsion (HIPE). The HIPE was subjected to photoinitiation and formed a porous poly(thiol-ene) materials, not particles as we are able to make. In another study, the authors examined the thiol-ene photopolymerization of commercially available adhesives in various solvent mixtures, including diglyme/water and acetone/isopropanol. [Guenthner, A. J.; Hess, D. M.; Cash, J. J. “Morphology Development in Photopolymerization-induced Phase Separated Mixtures of UV-Curable Thiol-Ene Adhesive and Low Molecular Weight Solvents” Polymer 2008, 49, 5533-5540]. It was found that during the polymerizations the homogeneous monomer/solvent mixture undergoes phase separation, and yielded either three-dimensional interconnected networks or polymer microspheres. The size and morphology of the resulting features were governed by polymerization rate, solvent evaporation rate and monomer-solvent ratio. No surfactants were used, nor was there any attempts to provide homogenization during the polymerization.

### Example 1

### Materials and Methods

It is noted that Example 1, and any other examples provided, are given by way of illustration only, since various changes and modifications within the spirit and scope of the invention will become apparent to those skilled in the art from this detailed description. Accordingly, the invention is not limited to the materials, conditions, or process parameters set forth in the examples

Materials:

1,3,5-triallyl-1,3,5-triazine-2,4,6 (1N,3H,5H)-trione (TTT), pentaerythritol tetrakis(3-mercaptopropionate) (PETMP), sodium dodecyl sulfate (SDS) and 1-hydroxycyclohexyl phenyl ketone were obtained from Sigma-Aldrich® and used without further purification. Solvents (chloroform and toluene) were obtained from VWR® Scientific and used without further purification.

Synthesis of Thiol-Ene Polymer Microspheres:

The suspension-like photopolymerization system for particle synthesis has been developed for both “small” scale and “large” scale reactions. Each experimental setup follows the same fundamental principles for the polymerization reaction. In general, the organic phase is added drop-wise to the stirring aqueous phase and stirred for 5-10 minutes followed by curing under ultra-violet (UV) light for 5-10 minutes. In a round bottom flask, a 5 or 10 wt. % SDS solution with 0.02% (mass/vol.) photoinitiator is made to create the aqueous phase. In a separate vial, an “organic phase” is prepared by combining the monomers TTT and PETMP (1:1 mole ratio of ene and thiol groups from TTT and PETMP, respectively) with a solvent (chloroform or toluene in a 1:1, 2:1, or 4:1 volume ratio of solvent to monomer). The two monomers constituted a 10 wt. % monomer to water mixture. “Small” scale reactions (total volume ˜10 ml) used magnetic stirring whereas “large” scale reactions (total volume ˜75 ml) used overhead stirring.

Synthesis of Thiol-Ene Polymer Sub-Micron Spheres.

Sub-micron spheres were synthesized in a similar manner to the microspheres discussed above except instead of stirring the reaction mixture before polymerization the reaction mixture was subjected to sonication by an Ace Glass sonic horn (Model GEX600, 20 Hz, 600 W) for 30 minutes. Twenty minutes after the sonication had finished the reaction was irradiated for 10 minutes with overhead stirring.

Characterization.

Analysis of general product material was performed using an Olympus optical microscope, where samples were prepared by simply air-drying, or scanning electron microscopy (SEM) using a JEOL JSM 7400 (for field-emission SEM) or JEOL JSM 6300 (for regular SEM) instruments. Differential scanning calorimetry (DSC) was performed on a TA Instruments Q100 instrument, with a heating rate of 10° C./min. Results from the second heating cycle are reported.

Although the present invention has been described in connection with a preferred embodiment, it should be understood that modifications, alterations, and additions can be made to the invention without departing from the scope of the invention as defined by the claims.

What is claimed is:

1. A method for suspension polymerization of thiol-ene particles, the method comprising the steps of:
combining a plurality of thiol-ene precursor monomers to create a first mixture;
combining an emulsifier and water to create a second mixture;
adding an initiator to the first or second mixture;
combining the first mixture and the second mixture to create a third mixture;
agitating the third mixture to create a heterogeneous dispersion; and
initiating polymerization of thiol-ene particles from the thiol-ene precursor monomers in said third mixture, wherein said third mixture is simultaneously agitated.

2. The method of claim 1, wherein said first or second mixture comprises a solvent.

3. The method of claim 1, wherein said initiator comprises a solvent.

4. The method of claim 1, wherein said thiol-ene precursor monomers are selected from the group consisting of: a thiol compound, an alkene, an aklyne, and combinations thereof.

5. The method of claim 4, wherein said thiol compound comprises one or more thiol groups.

6. The method of claim 4, wherein said, wherein said alkene comprises one or more alkene groups.

7. The method of claim 4, wherein said, wherein said alkyne comprises one or more alkyne groups.

8. The method of claim 1, wherein said second mixture further comprises a stabilizer.

9. The method of claim 1, wherein said polymerization is induced through photochemical, redox, or thermal means.

10. The method of claim 1, wherein said third mixture further comprises a first compound, wherein said first compound affects a characteristic of the polymerized thiol-ene particles.

11. The method of claim 10, wherein said characteristic is hardness, hydrophilicity, hydrophobicity, biocompatibility, particle size, stability, or a thermal property.

12. The method of claim 10, wherein said first compound is a diluent.

13. The method of claim 1, wherein the polymerized thiol-ene particles comprise a crosslinked structure.

14. The method of claim 1, wherein the polymerized thiol-ene particles comprise a linear structure.

15. The method of claim 1, wherein the polymerized thiol-ene particles comprise a diameter that is dependent upon the energy input of said agitation.

16. The method of claim 15, wherein diameter is between approximately 100 nm and 1 mm.

17. The method of claim 1, wherein after the polymerization is induced said third mixture comprises a solids content ranging between approximately 1% and 30%.

18. The method of claim 1, wherein said emulsifiers are selected from the group consisting of anionic emulsifiers, cationic or non-ionic emulsifiers, and combinations thereof.

19. The method of claim 1, wherein said solvents are added at a concentration of between approximately 0.01% and 20%.

20. The method of claim 1, wherein said initiator is a free radical initiator.

21. The method of claim 1, wherein said photoinitiator is selected from the group consisting of: a photoinitiator, a thermal initiator, a redox initiator, and combinations thereof.

22. The method of claim 1, wherein said initiator is added at a concentration of between approximately 0.05%-5%.
